(19) United States
(12) Patent Application Publication
(10) Pub. No.: US 2014/0071567 A1
(43) Pub. Date: Mar. 13, 2014

(54) SEMICONDUCTOR DEVICE

(71) Applicant: KABUSHIKI KAISHA TOSHIBA, Tokyo (JP)

(72) Inventor: Shoji SETA, Tokyo (JP)

(73) Assignee: Kabushiki Kaisha Toshiba, Tokyo (JP)

(21) Appl. No.: 13/780,000

(22) Filed: Feb. 28, 2013

(30) Foreign Application Priority Data
Sep. 10, 2012 (JP) 2012-198792

(51) Int. Cl. H02H 9/04

(52) U.S. Cl. CPC H02H 9/04
USPC 361/56

(57) ABSTRACT

A semiconductor device according to an embodiment includes a plurality of pads, a plurality of ESD protection circuits, each one of the ESD protection circuits being connected to a corresponding one of the plurality of pads, and an I/O circuit which is connected to a connection portion connecting output terminals of the plurality of ESD protection circuits to each other and which receives at least one input signal inputted into the plurality of pads.

### CROSS-REFERENCE TO RELATED APPLICATION

This application is based upon and claims the benefit of priority from the Japanese Patent Application No. 2012-198792, filed on Sep. 10, 2012; the entire contents of which are incorporated herein by reference.

### FIELD

An embodiment described herein relates generally to a semiconductor device.

### BACKGROUND

In an electronic device, in order to protect a circuit from electrostatic damage due to electrostatic discharge (hereinafter referred to as ESD), an ESD measure is taken.

For evaluation of ESD measures, ESD resistance evaluation based on a human body model (HBM) and a machine model (MM) has been conventionally performed at a level of an apparatus or a module. For example, ESD resistance evaluation is performed by applying, to an apparatus or a module to be evaluated, a voltage of 2 KV to 3 KV in the HBM or a voltage of 200 V in the MM.

Further, conventionally, ESD resistance of an electronic apparatus incorporating therein a semiconductor device, or a module of a semiconductor device has been evaluated, for example, by application of a voltage of 8 KV for contact discharge and a voltage of 15 KV for air discharge according to the ESD standard of IEC 61000-4.2. However, recently, the ESD resistance evaluation according to the above-described standard is sometimes required even at a level of pins of a semiconductor device chip.

Generally, in order to enable pins of a semiconductor device chip to meet an ESD resistance condition according to a predetermined standard, it is necessary to adopt, in the I/O design, a measure, such as strengthening the function of a power clamp circuit or reducing resistance of a wiring pattern by increasing a width of the wiring pattern.

However, the measure of increasing the width of the wiring pattern of a chip not only greatly restricts the layout design of the chip but also results in problems of an increase in the chip area, and an increase in the chip cost.

### BRIEF DESCRIPTION OF THE DRAWINGS

FIG. 1 is a view showing a chip layout image of a semiconductor device according to an embodiment;

FIG. 2 is a view for explaining a state where the semiconductor device of the embodiment is mounted in a semiconductor package;

FIG. 3 is a circuit diagram for explaining a configuration of an I/O unit including an ESD protection circuit 12 of a chip 1 of the embodiment;

FIG. 4 is a circuit diagram for explaining a configuration of a first modification of the semiconductor device of the embodiment;

FIG. 5 is a circuit diagram for explaining a configuration in which a plurality of ESD protection circuits 12 are provided for one pad 2c1 in the first modification of the semiconductor device of the embodiment;

FIG. 6 is a view for explaining a layout of pads 2c on a chip 1A and for explaining a configuration of a second modification of the semiconductor device of the embodiment; and

FIG. 7 is a view for explaining a layout of pads 2c on a chip 1B and for explaining a configuration of a third modification of the semiconductor device of the embodiment.

FIG. 8 is a circuit diagram for explaining a configuration of an I/O unit including an ESD protection circuit 12 of a chip 1C and for explaining a configuration of a fourth modification of the semiconductor device of the embodiment.

### DETAILED DESCRIPTION

A semiconductor device of an embodiment includes a plurality of first pads, a second pad connected to the plurality of first pads by bonding wires, a plurality of ESD protection circuits, each one of the ESD protection circuits being connected to a corresponding one of the plurality of first pads, an I/O circuit which is connected to output terminals of the plurality of ESD protection circuits.

### (Configuration)

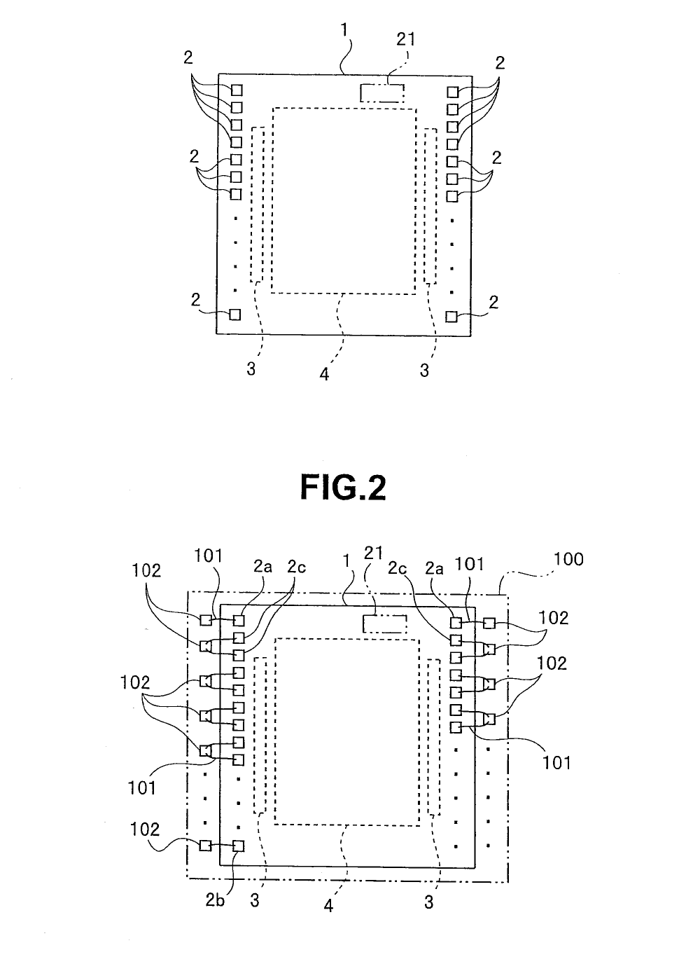

FIG. 1 is a view showing a chip layout image of a semiconductor device according to a present embodiment. FIG. 2 is a view for explaining a state where the semiconductor device of the present embodiment is mounted in a semiconductor package.

As shown in FIG. 1, on a semiconductor chip (hereinafter referred to simply as a chip) 1 of the present embodiment, a plurality of pads 2, to which, for example, bonding wires are connected, are arranged at each of two peripheral portions of the chip 1 linearly in parallel with two sides of the chip 1.

Note that, here, the plurality of pads 2 are arranged linearly at each of peripheral portions of the two sides of the chip 1, but the plurality of pads 2 may be arranged at each of peripheral portions of the four sides of the chip 1 or may also be arranged in a portion other than the peripheral portions of the four sides of the chip 1.

Pads 2a and 2b, which are a part of the plurality of pads 2 of the chip 1, are used as power source pads, and a plurality of pads 2c, which are a part of the plurality of pads 2, are used as input/output signal pads to be electrically connected with each other. As will be described below, the plurality of input/output signal pads 2c are connected to an I/O unit 3 including a plurality of ESD protection circuits using diodes. In the central portion of the chip 1, a logic circuit 4, which is a processing unit configured to realize various functions, is arranged. The central portion of the chip 1 may be a memory unit, or the like. Therefore, the central portion includes at least one of a logic circuit and a memory circuit, which receives the output signal from the I/O unit 3.

Note that, in the following description, a case where the I/O unit 3 including a plurality of ESD protection circuits is provided for input/output signal pads is described, but the I/O unit 3 including a plurality of ESD protection circuits may also be similarly provided for input signal pads.

As shown in FIG. 2, the chip 1 is enclosed and mounted in a semiconductor package 100 shown by the two-dot chain lines. By bonding wires 101 used as connection wiring means, the plurality of pads 2a,2b,2c of the chip 1 are connected to a plurality of electrode terminals (hereinafter referred to as external electrodes) 102 connected to a plurality of external connection terminals, such as pins or solder balls. A plurality of external connection terminals (not shown) of the semiconductor package 100 are connected to a plurality of lands of a printed wiring board, or the like, on which the semiconductor package 100 is mounted.

As shown in FIG. 2, a set of input signal pads 2c are connected to the plurality of external electrodes 102. In the FIG. 2, the set of input pads 2c are configured of two pads, but the number of the pads is not limited to two. The set of input pads 2c may be configured of three or more pads. A plurality of the pads 2c are electrically connected to each other by each of the plurality of external electrodes 102. A plurality of input signals are inputted into the chip 1, and each of the input signals is subjected to predetermined processing in the logic circuit 4. Various signals, each of which is subjected to the predetermined processing, are outputted as a plurality of output signals from the chip 1.

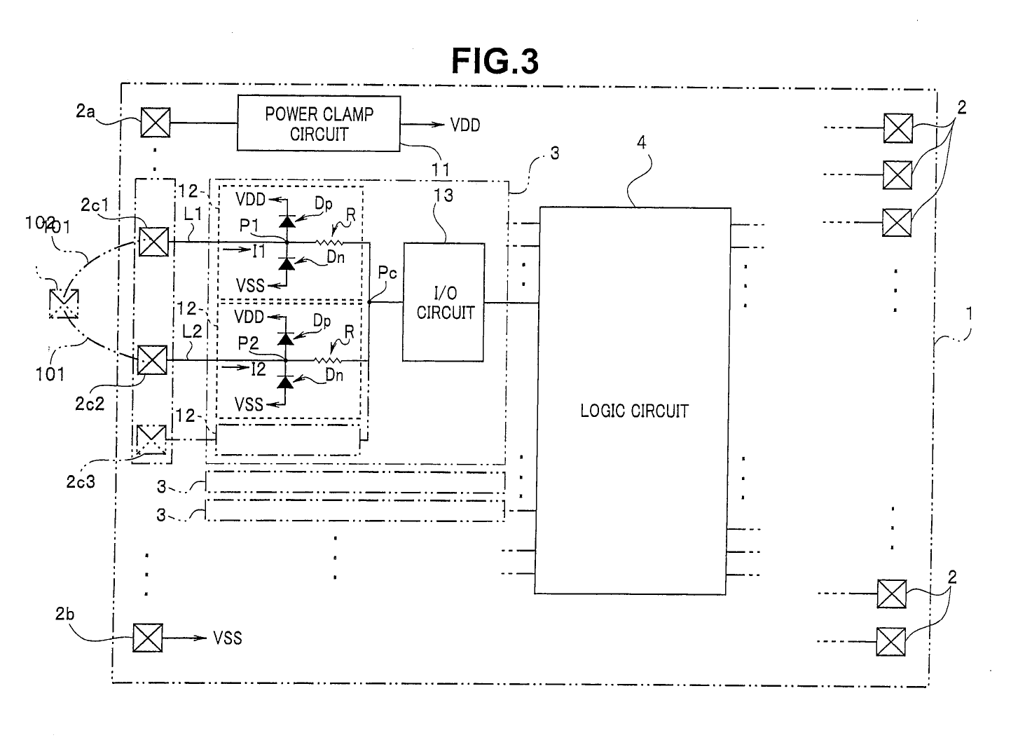

FIG. 3 is a circuit diagram for explaining a configuration of the I/O unit 3 of the chip 1, which unit includes ESD protection circuits 12. The pads 2a and 2b of the plurality of pads 2 are used as power source pads. For example, the pad 2a is an electrode to which a power source voltage VDD is applied, and the pad 2b is an electrode to which a ground potential VSS is connected. A power clamp circuit 11 is provided between the pads 2a and 2b. Note that, in FIG. 3, each one of the pad 2a and the pad 2b is shown as the power source pad 2, but a plurality of the pads 2a and a plurality of the pads 2b may also be provided in the chip 1.

Further, in FIG. 3, pads 2c1 and 2c2 are input signal electrodes of the plurality of pads 2. The pads 2c1 and 2c2 are a set of pads which are connected to the one external electrode 102 and which are used for inputting one input signal. The pads 2c1 and 2c2 are connected to the one external electrode 102 in the semiconductor package 100 by two of the bonding wires 101.

In FIG. 3, only the pads 2c1 and 2c2 for an input signal inputted to the one external electrode 102 are shown, but a plurality of sets of the input signal pads 2c are provided on the chip 1. Each set of the pads 2c are respectively connected to one corresponding external electrode 102 by a plurality of the bonding wires 101.

Note that here, the two pads 2c1 and 2c2 are provided for one input signal inputted to the external electrode 102. However, as shown by two-dot chain lines in FIG. 3, three pads 2c1, 2c2 and 2c3 may be provided for one input signal, and although not illustrated, four or more pads may also be provided for one input signal. That is, three or more pads 2c may be provided for the external electrode to which each input signal is inputted.

Further, note that here, the I/O unit 3 including a plurality of the ESD protection circuits 12 is provided for each of the input signals, but the I/O unit 3 including a plurality of the ESD protection circuits 12 may also be provided for at least one of a plurality of input signals of the chip 1.

As described above, a set of the pads 2c1, and 2c2 are provided for each of the plurality of input signals in the chip 1.

Each of the pads 2c1 and 2c2 is connected to the ESD protection circuit 12 including two diodes Dp and Dn and a resistor R. As shown in FIG. 3, the pads 2c1 and 2c2 are respectively connected to connection points P1 and P2, each of which is connected to the two diodes Dp and Dn, and one end of the resistor R.

Specifically, the pad 2c1 is connected to the ESD protection circuit 12. The cathode of the diode Dp of the ESD protection circuit 12 is connected to the power source voltage VDD. The anode of the diode Dp is connected to the cathode of the diode Dn. The anode of the diode Dn is connected to the ground potential VSS which is a reference potential. The pad 2c1 is connected to the connection point P1 of the diodes Dp and Dn.

The pad 2c2 is also connected to the ESD protection circuit 12 having the same configuration, and is connected to the connection point P2 of the two diodes Dp and Dn of the ESD protection circuit 12.

Each of the plurality of pads 2c is respectively connected to one ESD protection circuit 12. That is, one external electrode 102 is connected to the plurality of ESD protections 12.

Further, the one end of each of the two resistors R is connected to each of the connection points P1 and P2, and the other ends of the resistors R are connected to each other at a connection point Pc. The potential of the connection point Pc is inputted into an I/O circuit 13.

That is, the I/O circuit 13 is connected to the connection point Pc serving as a connecting unit for mutually connecting the output terminals of the two ESD protection circuits 12, and receives the input signals inputted into the two pads 2c1 and 2c2.

The I/O circuit 13 includes a buffer circuit, an input/output conversion circuit, or the like, which include a transistor and a resistor. The output of the I/O circuit 13 is inputted into the logic circuit 4.

### (Operation)

Next, the operation of the chip 1 shown in FIG. 1 to FIG. 3 is described.

One input signal inputted to the external electrode 102 is inputted to the two pads 2c1 and 2c2 respectively via the bonding wires 101 which are two signal lines.

A current of the input signal is branched so as to flow into the two pads 2c1 and 2c2, and two branched currents I1 and I2 are respectively inputted into the ESD protection circuits 12 via wirings L1 and L2. Output terminals of the two ESD protection circuits 12 are mutually connected at the connection point Pc, and hence the currents outputted from the two ESD protection circuits 12 are joined with each other at the connection point Pc, so as to be inputted into the I/O circuit 13. The input signal outputted from the I/O circuit 13 is inputted into the logic circuit 4, so as to be subjected to predetermined processing.

For example, when a high electrostatic voltage is applied to one of the external electrodes 102, the voltage is also applied to the pads 2c1 and 2c2 via the two bonding wires 101.

However, a current I generated by the voltage applied to the external electrode 102 is branched to the two pads 2c1 and 2c2, and the currents I1 and I2 respectively flowing into the two pads 2c1 and 2c2 are made to respectively flow into the corresponding ESD protection circuits 12 via the wiring L1 and L2.

Since the two wirings L1 and L2 are respectively connected to the ESD protection circuits 12 in parallel with each other, the currents I1 and I2 respectively flowing into the wirings L1 and L2 are reduced, so as to provide a margin for a resistance value of the wirings L1 and L2. Further, for example, when the wirings L1 and L2 have the same wiring pattern width and the same length, each of the currents I1 and I2 respectively flowing through the wiring L1 and L2 is reduced to be a half of the whole current I, and hence the charges of each of the currents I1 and I2 are easily released to the VDD side or the VSS side via the diode Dp or the diode Dn of the ESD protection circuit 12. As a result, the I/O circuit 13 and the logic circuit 4 are hardly destroyed.

In the conventional semiconductor device in which the configuration like the present embodiment described above is not used, measures, such as strengthening the function of a power clamp circuit, and increasing the width of a wiring pattern, are taken. For example, when the wiring pattern width is increased, the whole area of the circuit unit, which is configured by the pad, the ESD protection circuit 12, and the I/O circuit 13, is increased.

However, in the case of the configuration of the present embodiment described above, although a plurality of pads and the two ESD protection circuits 12 are provided for one input signal, the wiring pattern width needs not be increased, and the size of the plurality of pads can be made smaller than the size of the conventional pad. Therefore, the increase in the chip area can be suppressed.

Further, even when the plurality of the pads and the plurality of the ESD protection circuits 12 are provided for one input signal, one I/O circuit 13 is used.

Therefore, even when each of the number of pads 2c and the number of the ESD protection circuits 12 is set to two, three, or four for one input signal, only one I/O circuit 13 is required, and hence the whole area of the circuit configured by the pads, the ESD protection circuits 12, and the I/O circuit 13 is not doubled, tripled, or quadrupled. For example, in the case where the area ratio of the pad, the ESD protection circuit 12, and the I/O circuit 13 is set as 4:1:5, even when each of the number of the pads and the number of the ESD protection circuits is increased to two, three or four, the whole area of the circuit configured by the pads, the ESD protection circuits 12, and the I/O circuit 13 in the present embodiment is not doubled, tripled, or quadrupled but becomes 1.5 times, 2 times, or 2.5 times.

Therefore, with the present embodiment, it is possible to realize a semiconductor device which can improve ESD resistance of pins of a chip without increasing the width of the wiring pattern of the chip. As a result, it is possible to prevent a significant increase in the chip area and the chip cost in the semiconductor device.

Next, several modifications will be described.

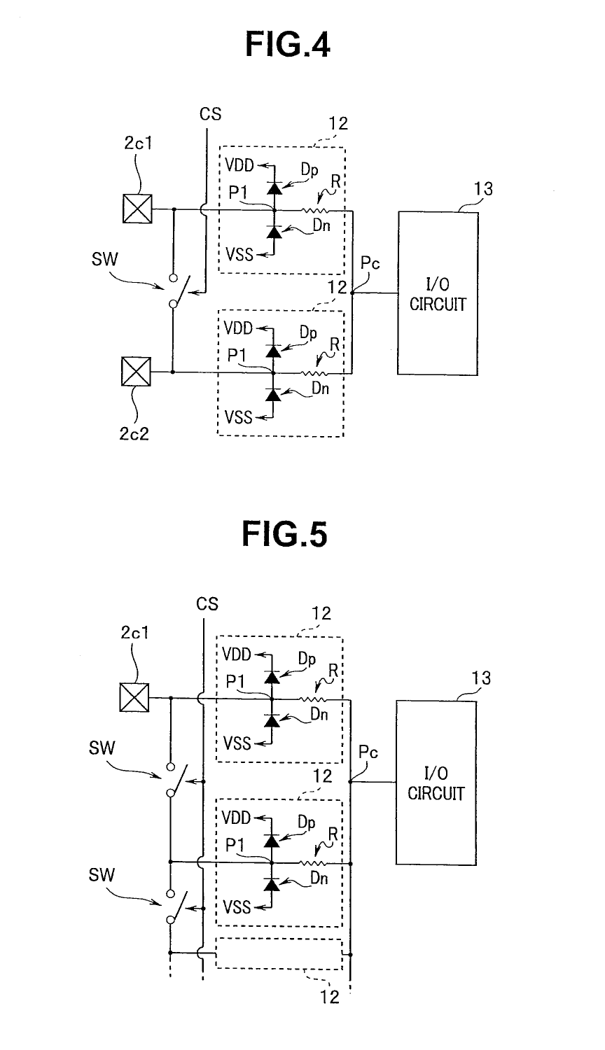

FIG. 4 is a circuit diagram for explaining a configuration of a first modification of the semiconductor device of the present embodiment. FIG. 4 shows only two pads 2c1 and 2c2 to which one input signal is inputted. As shown in FIG. 4, a switch SW is provided between the pads 2c1 and 2c2. Both terminals of the switch SW are connected to the pad 2c1 and 2c2, respectively. The opening and closing of the switch SW are controlled by a switch control signal CS. When the switch SW is closed by the switch control signal CS, the two pads 2c1 and 2c2 are electrically connected to each other.

A switch control circuit 21 configured to output the switch control signal CS for controlling the opening and closing of the switch SW is provided on the chip 1 as shown by the two-dot chain lines in FIG. 1 and FIG. 2. The switch control circuit 21 itself configures a switch control unit which controls the output of the switch control signal CS for controlling the opening and closing of the switch SW.

The switch SW is used in the case where, in a state of the chip 1 before the chip 1 is mounted in the semiconductor package 100, ESD evaluation of the chip is performed by simultaneously applying an electrostatic voltage to the two pads 2c1 and 2c2.

That is, in the state of chip 1, ESD evaluation can be performed by applying a predetermined voltage for ESD evaluation to each of the two pads 2c1 and 2c2. Further, when the switch SW is provided between two pads 2c1 and 2c2, ESD evaluation can also be performed in the same state as the state where a predetermined voltage is applied to the external electrode 102 corresponding to the two pads 2c1 and 2c2.

Specifically, when a predetermined voltage is applied to each of the two pads 2c1 and 2c2, ESD evaluation can be performed for each of the pads in the state of the chip 1. Further, when the switch SW is closed, it is also possible to create a state where a predetermined voltage is simultaneously applied to the two pads 2c1 and 2c2 as if the two pads 2c1 and 2c2 were connected to the external electrode 102.

Therefore, in the state of the chip 1 before the chip 1 is mounted in the semiconductor package 100, when the switch SW is controlled to be closed by the switch control circuit 21, it is possible to perform ESD evaluation in the same state as if the two pads 2c1 and 2c2 were connected to the external electrode 102, and a predetermined voltage was applied to the external electrode 102.

Note that, when three or more pads 2c are provided for one input signal, each of a plurality of switches SW is provided between each mutually adjacent pair of the three or more pads 2c. Further, the plurality of switches SW are provided so that a predetermined voltage can be simultaneously applied to the plurality of pads 2c at the time when all of the plurality of switches SW are closed.

Note that, in the first modification shown in FIG. 4, the two pads 2c1 and 2c2 are electrically connected to each other via the switch SW to thereby enable a common signal to be inputted into the two ESD protection circuits 12. However, the number of the pads does not necessarily need to be the same as the number of the ESD protection circuits.

FIG. 5 is a circuit diagram for explaining a configuration in which a plurality of the ESD protection circuits 12 are provided for one pad 2c1 in the first modification of the semiconductor device of the present embodiment. That is, as shown in FIG. 5, even when the pad 2c2 is not provided, one input signal is inputted in parallel to the plurality of ESD protection circuits 12 by closing switches SW, and hence the ESD resistance is improved.

The configuration as shown in FIG. 5 is effective in the case where a large area of the chip is taken by the I/O unit because of reducing pad numeral.

Therefore, the ESD resistance is improved by making one input signal pass through one pad and a plurality of ESD protection circuits, or by making one input signal pass through a plurality of pads and a plurality of ESD protection circuits.

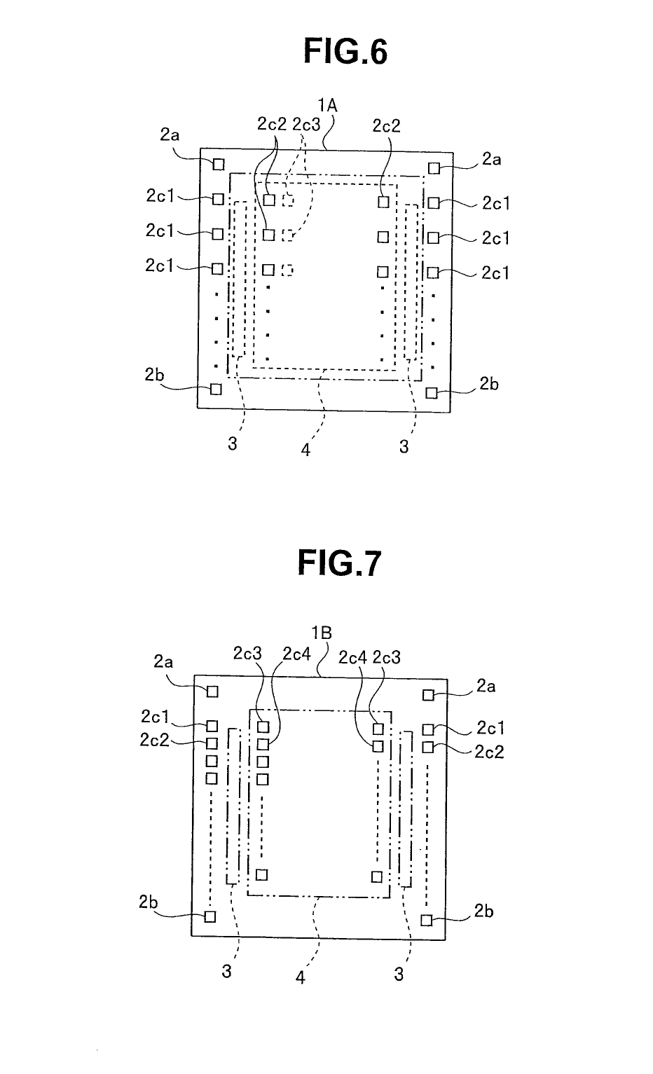

FIG. 6 is a view for explaining a layout of pads 2c on a chip 1A and for explaining a configuration of a second modification of the semiconductor device of the present embodiment.

In the case of FIG. 1 and FIG. 2 described above, the plurality of pads provided on the chip 1 are arranged in a row along each of the two sides of the chip 1, but in the second modification, one of the two pads 2c1 and 2c2 is arranged in a direction perpendicular to each of the sides of the rectangular chip 1A, for example.

That is, at least one of a plurality of pads 2c is arranged the inside of the chip 1A. An angle between the side of the rectangular chip 1A and the direction of pads is not limited to a right angle.

As shown in FIG. 6, the pad 2c1 of the two pads is provided near each of the two sides of the chip 1A, and the other pad 2c2 is arranged just above the logic circuit 4, for example. The other pad 2c2 is provided so as to be laminated on the layer in which the ESD protection circuit 12 or the I/O circuit 13 of the chip 1A are formed.

Note that, when three pads 2 are provided for one input signal, the third pad 2c3 is provided, as shown by dotted lines in FIG. 6, on the inner side from the pad 2c2 on the chip 1A in the direction perpendicular to one side of the chip 1A. Also, when four pads 2 are provided for one input signal, the fourth pad is provided on the inner side from the third pad on the chip 1A in the direction perpendicular to the one side of the chip 1A similarly to the third pad. The angle between the side of the chip 1A and the direction of pads is also not limited to a right angle.

In these configurations, the plurality of pads 2c are not arranged along only one side of the chip 1A. Therefore, even when the number of pads is doubled (or tripled or more), the size of the chip 1A along the one side thereof needs not be increased according to the increase in the number of pads, and hence the chip 1A can be made compact.

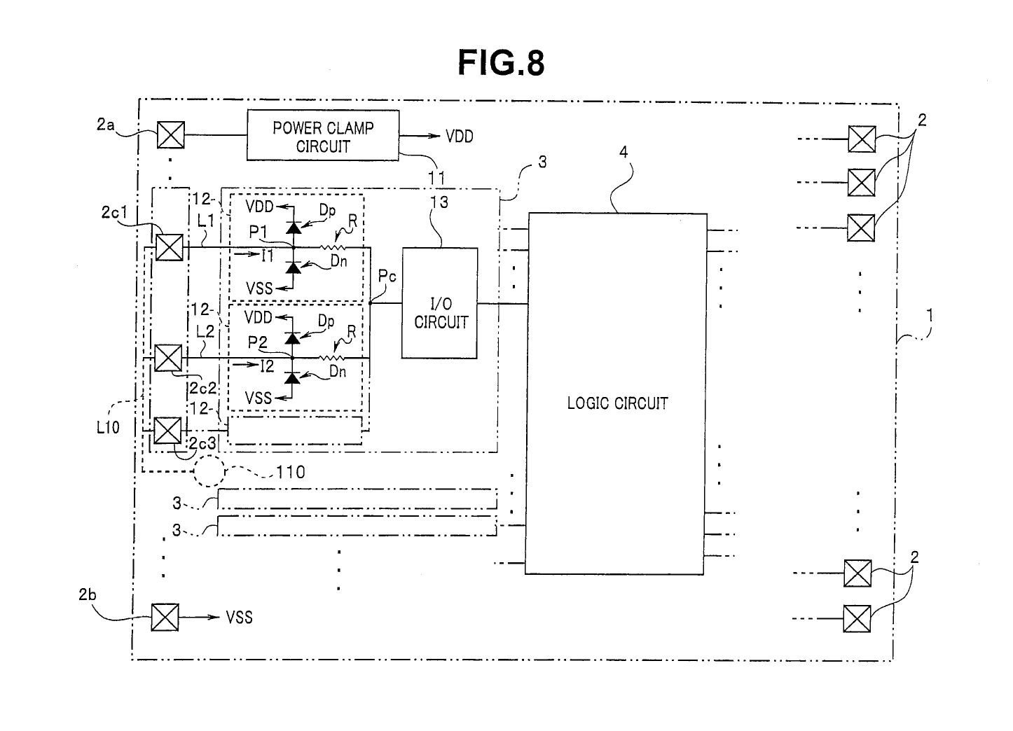

FIG. 7 is a view for explaining a layout of pads 2c on a chip 1B and for explaining a configuration of a third modification of the semiconductor device of the present embodiment.

In the third modification, when four pads 2c are provided for one input signal, as shown by the dotted lines in FIG. 7, two of the four pads 2c for one input signal are arranged along an edge of the chip 1B, and the other two of the four pads 2c are arranged the inside of the chip 1B.

Specifically, when four pads 2c1, 2c2, 2c3 and 2c4 are provided for one input signal as shown in FIG. 7, the two pads 2c1 and 2c2 of the four pads are arranged along each of the sides of the chip 1B, and the other two pads 2c3 and 2c4 are arranged the inside of the chip 1B.

That is, a part of the plurality of pads 2c is arranged linearly along at least one side of the chip 1B, and a remaining part of the plurality of pads 2c is arranged the inside of the chip 1B.

Even the above-described configuration provides an effect that the size of the chip 1B in the direction of the side of the chip 1B needs not be increased according to an increase in the number of pads.

Note that, here, a case is described in which four pads 2c are provided for one input signal. In the case where more pads 2c are provided, it may also be configured such that the plurality of pads 2c are arranged in an n×n matrix form in such a manner that n pads 2c are arranged along each of the edges of the chip 1B, and that the remaining n pads 2c are further arranged the inside of the chip 1B.

Further, in the case where a plurality of pads are provided for one input signal, it may also be configured such that the number of pads 2c arranged along one side of the chip 1B is different from the number of pads 2c arranged along the inside of the chip 1B.

FIG. 8 is a circuit diagram for explaining a configuration of an I/O unit including an ESD protection circuit 12 of a chip 1C and for explaining a configuration of a fourth modification of the semiconductor device of the embodiment. FIG. 8 shows the modification in which the embodiment is applied to WLCSP (Wafer Level Chip Size Package). In FIG. 8, the same components as those in FIG. 3 are attached with the same reference numerals and descriptions thereof are omitted.

Pads 2c1, 2c2, and 2c3 are pads for an input signal. The pads 2c1, 2c2 and 2c3 are commonly connected to an external electrode 110. The pads 2c1, 2c2 and 2c3 are connected to an external electrode 110 via a wiring L10.

The external electrode 110 is formed on the upper layer of the pads 2c1, 2c2 and 2c3, the ESD protection circuit 12, the I/O circuit 13, and the logic circuit 4. In FIG. 8, for simplification, only one external electrode 110 is illustrated. However, the number of the external electrode 110 is not limited to one, and a plurality of external electrodes 110 are formed in an array on the upper layer of the logic circuit 4 and the like. In addition, the external electrode 110 forms a ball electrode, and performs input and output of signals to and from outside the chip.

The external electrode 110 is formed on the upper layer of the pads 2c1, 2c2 and 2c3, the logic circuit 4, and the like, thereby capable of fabricating the semiconductor device which can reduce the chip area and improve the ESD resistance without increasing the width of the wiring pattern.

In this way, with the present embodiment and each of the modifications as described above, it is possible to realize a semiconductor device which can improve ESD resistance of pins of a chip without increasing the width of the wiring pattern of the chip. As a result, a large increase in the chip area, and an increase in the chip cost can be prevented in the semiconductor device.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. A semiconductor device comprising:
a plurality of first pads;
a plurality of ESD protection circuits, each one of the ESD protection circuits being connected to a corresponding one of the plurality of first pads; and
an I/O circuit connected to output terminals of the plurality of ESD protection circuits.

2. The semiconductor device according to claim 1, further comprising
an external electrode connected to the plurality of first pads,
wherein the plurality of first pads are respectively connected to the external electrode by bonding wires.

3. The semiconductor device according to claim 1, further comprising
a switch unit provided between the plurality of first pads, and
a switch control unit configured to control opening and closing of the switch unit.

4. The semiconductor device according to claim 1,
wherein the plurality of first pads are arranged linearly along at least one side of the semiconductor device.

5. The semiconductor device according to claim 1,
wherein the plurality of first pads are arranged the inside of the semiconductor device.

6. The semiconductor device according to claim 1,
wherein a part of the plurality of first pads is arranged linearly along at least one side of the semiconductor chip, and a remaining part of the plurality of first pads is arranged the inside of the semiconductor device.

7. The semiconductor device according to claim 5,
wherein the plurality of first pads arranged the inside of the semiconductor device are laminated over a layer in which the ESD protection circuit are arranged.

8. The semiconductor device according to claim 6,
wherein the plurality of first pads arranged the inside of the semiconductor device are laminated over a layer in which the ESD protection circuit are arranged.

9. The semiconductor device according to claim 2,
the external electrode is configured of ball electrode.

10. The semiconductor device according to claim 9,
the external electrode is formed on upper of a layer different from the plurality of ESD protection circuits.

11. The semiconductor device according to claim 10,
the semiconductor device is configured of WLCSP (Wafer Level Chip Size Package).

12. The semiconductor device according to claim 2,
the external electrode is configured of an electrode for an input signal.

13. The semiconductor device according to claim 5,
wherein a semiconductor chip of the semiconductor device has a rectangular shape, and
the plurality of first pads are arranged along a direction perpendicular to at least one side of the semiconductor device.

14. The semiconductor device according to claim 6,
wherein a semiconductor chip of the semiconductor device has a rectangular shape, and
the plurality of first pads are arranged along a direction perpendicular to at least one side of the semiconductor device.

15. A semiconductor device comprising:
at least one pad;
a plurality of ESD protection circuits;
a switch unit inserted between input terminals of the plurality of ESD protection circuits; and
an I/O circuit connected to output terminals of the plurality of ESD protection circuits,
wherein the one pad is connected to a first ESD protection circuit directly, and at least one second ESD protection circuit by closing the switch unit.

16. The semiconductor device according to claim 15, further comprising
an external electrode connected to the one pad,
wherein the one pad is connected to the external electrode by bonding wires.

17. The semiconductor device according to claim 16,
wherein the external electrode is configured of ball electrode.

18. The semiconductor device according to claim 17,
the external electrode is formed on upper of a layer different from the plurality of ESD protection circuits.

19. The semiconductor device according to claim 18,
the semiconductor device is configured of WLCSP (Wafer Level Chip Size Package).

20. The semiconductor device according to claim 16,
the external electrode is configured of an electrode for an input signal.
